(19) United States
(12) Patent Application Publication
(10) Pub. No.: US 2003/0236887 A1
(43) Pub. Date: Dec. 25, 2003

(54) Cluster bandwidth management algorithms

(75) Inventors: Alex Kesselman, Ramat Gan (IL); Amos Peleg, Givataim (IL)

Correspondence Address: DR. MARK FRIEDMAN LTD., C/O BILL POLKINGHORN, DISCOVERY DISPATCH, 9003 FLORIN WAY, UPPER MARLBORO, MD, 20772, US

(73) Assignee: Check Point Software Technologies Ltd.

(21) Appl. No.: 10/176,177

(22) Filed: Jun. 21, 2002

(51) Int. Cl. G06F 15/173

(52) U.S. Cl. 709/226; 709/228; 709/233

(57) ABSTRACT

A method to manage the bandwidth of a link that is available to a cluster of servers. The method includes establishing a localized bandwidth management policy for at least one of the servers from a centralized management policy of the cluster. The localized policy and the centralized policy are based on a hierarchical policy having a plurality of rules associated with classes of connections that are routed through the link. Each of the rules has an associated rate. The plurality of rules includes a plurality of terminal rules. Establishing the localized policy is performed by prorating the rate of at least one of the terminal rules under the centralized policy according to a first measurement of a usage of the link by the at least one server for the at least one terminal rule. The method also includes operating the at least one server according to the localized policy.

### FIELD AND BACKGROUND OF THE INVENTION

The present invention relates to bandwidth management algorithms and, in particular, it concerns managing the bandwidth of a link which is used by a cluster of servers.

In today's competitive business environment, service providers and enterprises strive to increase market share, deliver better service, and provide high returns for their shareholders. The Information Technology (IT) infrastructure is playing an increasingly important role in accomplishing these goals. Be it internal requirements such as, the timely provision of mission-critical applications such as SAP or Oracle Financial, or outward facing requirements such as web hosting and e-commerce, the very importance of the IT infrastructure mandates high-availability, load sharing and scalable Quality of Service (QoS) solutions.

The single strong server solution is expensive, is not scaleable and requires service interruption for maintenance and upgrading. A server cluster is a group of servers that cooperate, providing high bandwidth and reliable access to the Internet. Unlike the strong server solution, server clusters do not have a single point of failure, so if a server goes down, there is another server available for the traffic. The traffic is divided among the servers by a load-sharing device. The load-sharing device monitors the load on each server, and routes the traffic accordingly. The load-sharing device also maximizes the efficient use of the servers, and protects against Internet inaccessibility by routing traffic away from overloaded or down servers. All servers of the cluster share the same set of so called “virtual” interfaces. Each virtual interface corresponds to a network access link. Typically, each network access link has an associated maximum bandwidth rate. If the bandwidth rate limit is exceeded either traffic may be lost and/or an expensive monetary fine may be incurred. Therefore, it is essential that the bandwidth rate limit per network access link be adhered to.

Quality of Service includes a number of techniques that intelligently match the needs of specific applications to the network resources available by allocating an appropriate amount of network bandwidth rate. The result is that applications identified as “business critical” can be allocated the necessary priority and bandwidth rates to run efficiently. Applications that are identified as less than critical can be allocated a “best effort” bandwidth rate and thus run at a lower priority. Weighted fair queuing (WFQ) is an important QoS technique, which applies priority or weights to identified traffic to classify traffic into connections and determine how much bandwidth rate each connection is allowed relative to other connections based on a service class allocation of the connections. Traffic is identified by its characteristics, such as, source and destination address, protocol, and port numbers. In packet-switched networks, packets from different connections belonging to different service classes interact with each other when they are multiplexed at the network access link. It is important to design scheduling algorithms that allow statistical multiplexing on the one hand, and offer protection among connections and service classes on the other hand. In other words, it is important to prioritize connections according to a set of priority rules based on their service class and utilize the total bandwidth rate available per network access link without exceeding the network access link bandwidth rate limit. WFQ was described by Shenker, Demers, and Keshav in “Analysis and Simulation of a Fair Queueing Algorithm”, in Proceedings Sigcomm '89, pp. 1-12, September 1989 and also by Parekh and Gallager in “A Generalized Processor Sharing Approach to Flow Control—the Single Node Case”, in Proceedings of Infocom '92, vol. 2, pp. 915-924, May 1992. The two proceeding publications are hereby incorporated by reference in their entirety as if set out herein.

Reference is now made to FIG. 1, which is a hierarchical link-sharing example according to the prior art. A link 10 is shared among different service classes using hierarchical link sharing implementing a WFQ algorithm. With hierarchical link sharing, a service class hierarchy specifies the resource allocation policy for the link. A service class or rule represents some aggregate of traffic that is grouped according to administrative affiliation, protocol, traffic type and other criteria. Each service class or rule of traffic may be prioritized, by setting its weight, so the higher priority classes or rules are first in line for borrowing resources during periods of link congestion or over-subscription. This hierarchical link sharing approach allows multiple traffic types to share the bandwidth rate of a link in a well-controlled fashion, providing an automated redistribution of idle bandwidth rate. Link 10 has a plurality of sub-rules, which are divided into terminal rules 12 and non-terminal rules 14. Terminal rules 12 do not have any sub-rules whereas non-terminal rules 14 have sub-rules which are either non-terminal rules 14 or terminal rules 12. A given connection is associated with only one terminal rule. All connections matching a given terminal rule share the bandwidth rate allocated to the given terminal rule equally. A connection is defined as backlogged if its queue is not empty. Therefore, the bandwidth rate available to a given connection depends on the allocated bandwidth rate of the given terminal rule matching the given connection and the amount of backlogged connections currently matching the given terminal rule. A rule is defined as “active” if at least one connection matching that rule is backlogged. Otherwise, the rule is defined as “inactive”. In the illustration of FIG. 1, the bandwidth rate of link 10 is divided between its sub-rules 16, 18 according to the weights allocated to sub-rules 16, 18. It should be noted that a systems administrator typically determines the weights of all the rules in the hierarchy. In the illustration of FIG. 1, the weights set by the systems administrator are not shown. However, in FIG. 1, the resulting rates of the rules are shown, which are in themselves equivalent to the weights of the rules. The bandwidth rate of sub-rule 16 is divided between its sub-rules 20, 22 according to the weights of sub-rules 20, 22. The bandwidth rate of sub-rule 18 is similarly divided among its sub-rules according to the weighting of the sub-rules of sub-rule 18. This process continues until the bandwidth is divided among all terminal rules 12. For example, if sub-rule 18 is inactive then the bandwidth rate available to sub-rule 18 is allocated to sub-rule 16. This additional bandwidth is allocated among the sub-rules of sub-rule 16 according to the weighting of the sub-rules of sub-rule 16. As a further example, if sub-rule 22 is inactive then the bandwidth rate available to sub-rule 22 is allocated to sub-rule 20. This additional bandwidth is allocated among the sub-rules of sub-rule 20 according to the weighting of the sub-rules of sub-rule 20. Therefore, there is a centralized bandwidth management policy for allocating bandwidth to connections based on the rates of the rules, where the rates of the rules are computed from the weighting allocation of the rules and the activity status of the rules. The centralized bandwidth management policy takes into account inactive rules thereby making best use of the total available bandwidth of the link without exceeding the total available bandwidth of the link. Therefore, each class of traffic is typically able to receive roughly its allocated bandwidth in times of congestion; and when a class is not using its allocated bandwidth, the excess bandwidth is fairly distributed among other classes.

The above solution can be applied to a single strong server solution with effective results. However, as mentioned above using a single strong server as disadvantages. Therefore, it is advantageous to apply the centralized bandwidth management policy to a cluster of servers. However, as each server in the cluster shares the link and one server may be processing connections matching a rule and another server may be processing connections matching the same rule, the application of the centralized bandwidth management policy to a cluster of servers is not straightforward. Prior art attempts to apply the centralized bandwidth management policy to a cluster of servers require separate configuration of the individual servers. This process is not dynamic and results in the centralized policy being applied on a non-optimal basis.

Therefore there is a need to manage the bandwidth of a link which is shared by a cluster of servers in a similar manner as a single server manages a link under a centralized bandwidth management policy.

### SUMMARY OF THE INVENTION

The present invention is a method for managing the bandwidth of a link which is used by a cluster of servers.

According to the teachings of the present invention there is provided, a method to manage a bandwidth of a link that is available to a cluster of servers, comprising the steps of: (a) establishing a localized bandwidth management policy for at least one of the servers at least partially from a centralized management policy of the cluster, the localized policy and the centralized policy being based on a hierarchical policy having a plurality of rules associated with classes of connections that are routed through the link, each of the rules having an associated rate, the plurality of rules including a plurality of terminal rules, the step of establishing being performed by prorating the rate of at least one of the terminal rules under the centralized policy according to a first measurement of a usage of the link by the at least one server for the at least one terminal rule; and (b) operating the at least one server according to the localized policy.

According to a further feature of the present invention, the first measurement is measured by a quantity of backlogged connections.

According to a further feature of the present invention, the step of establishing is performed by all of the servers.

According to a further feature of the present invention, the step of establishing is performed by the at least one server.

According to a further feature of the present invention, the step of establishing is performed by another of the servers for the at least one server.

According to a further feature of the present invention, the step of establishing includes computing the rate of the at least one terminal rule under the centralized policy from a weighting allocation and an activity status of at least one of the rules for the cluster.

According to a further feature of the present invention: (a) the plurality of rules includes a plurality of non-terminal rules; and (b) the step of establishing includes computing the rate of at least one of the non-terminal rules under the localized policy such that, the rate of the at least one non-terminal rule is substantially equal to a sum of the rates of the terminal rules which are below the at least one non-terminal rule under the localized policy.

According to a further feature of the present invention, the step of establishing includes computing an interface speed for the at least one server such that, the interface speed is proportional to a sum of the rates of the terminal rules under the localized policy.

According to a further feature of the present invention, there is also provided the step of creating a phase state table by one of the servers, wherein the phase state table has a data set which includes, for each of the servers, a second measurement of the usage of the link for each of the terminal rules.

According to a further feature of the present invention, the second measurement is measured by a quantity of backlogged connections.

According to a further feature of the present invention, the step of creating is performed on a periodic basis.

According to a further feature of the present invention, the step of creating is performed when one of the terminal rules becomes active for a first time since the step of establishing was performed.

According to a further feature of the present invention, the step of establishing is performed using the data set of the phase state table.

According to a further feature of the present invention, there is also provided the step of at least one of the servers maintaining a current state table, wherein the current state table has a data set which includes, for each of the servers, a current measurement of the usage of the link for each of the terminal rules.

According to a further feature of the present invention, the current measurement is measured by a quantity of backlogged connections.

According to a further feature of the present invention, there is also provided the step of deleting the data set of the current state table which is associated with one of the servers after a predefined timeout.

According to a further feature of the present invention, the step of maintaining includes synchronizing at least part of the data set of the current state table between at least two of the servers.

According to a further feature of the present invention, the step of creating is performed by using the data set of the current state table to form the phase state table.

According to a further feature of the present invention, there is also provided the step of distributing the phase state table to at least another of the servers.

According to a further feature of the present invention, there is also provided the steps of: (a) prior to completion of the step of distributing, assigning a new phase number to the phase state table such that the new phase number is equal to a phase number of a previous phase state table plus one; and (b) distributing the phase state table with the new phase number.

According to a further feature of the present invention the step of establishing is performed by one of the servers when the new phase number is greater than a local phase number, which is maintained locally by one of the servers; the method further including the step of setting the local phase number to be equal to the new phase number.

### BRIEF DESCRIPTION OF THE DRAWINGS

The invention is herein described, by way of example only, with reference to the accompanying drawings, wherein:

FIG. 1 is a hierarchical link-sharing example according to the prior art;

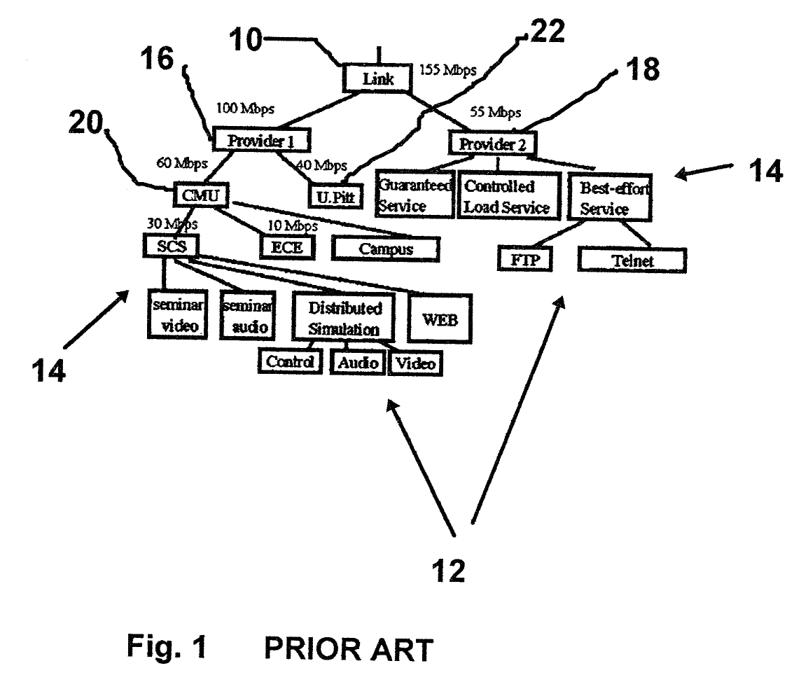

FIG. 2 is a flowchart of some of the steps performed during a phase that is operable in accordance with a preferred embodiment of the invention;

FIG. 3 is an example of a centralized policy rate hierarchy that is constructed and operable in accordance with a preferred embodiment of the invention;

FIG. 4 is a localized policy rate hierarchy for a server computed with reference to the centralized policy rate hierarchy of FIG. 3.

### DESCRIPTION OF THE PREFERRED EMBODIMENTS

The present invention is a method for managing the bandwidth of a link which is used by a cluster of servers.

The principles and operation of the bandwidth management method according to the present invention may be better understood with reference to the drawings and the accompanying description. It will be apparent to those skilled in the art that the teachings of the present invention can be applied to be used with various allocation policies, including any weighted bandwidth allocation (WBA) policy, for example, Weighted Round Robin (WRR) and Deficit Round Robin (DRR) scheduling policies.

The bandwidth of a link that is available to a cluster of servers is managed by establishing a localized bandwidth management policy for each of the servers of the cluster based on a centralized policy. Therefore, each server operates according to its localized policy in a similar manner as a single server operates under the centralized policy. Each localized policy is based on a hierarchical policy having a plurality of rules associated with classes of connections that are routed through the link. Each of the rules has an associated rate. The rules include a plurality of terminal rules. It should be noted that the hierarchical policy typically has several levels incorporating a root, non-terminal rules and terminal rules. However, it is possible to structure a flat hierarchy that only has a root and a plurality of terminal rules.

In the most preferred embodiment of the invention each server computes its own localized policy. However, in an alternate embodiment of the invention one server computes a localized policy on behalf of another server in the cluster. It should be noted that it is preferable for each server to compute its own localized policy so as not to rely upon another server which could fail.

The localized policies of all the servers are calculated from the same data set to ensure that the link bandwidth is utilized in full without being exceeded. Therefore, all servers calculate the rates of their rules under a localized policy with respect to the same state. In other words, the establishment of the localized policies is computed with respect to data which represents the state of the system, as a whole, at a given time. Since the cluster's state typically changes dynamically, the localized policies are updated periodically. The time period between two consecutive updates of the localized policies is known as a phase. Therefore, the localized policies of each server are computed periodically with respect to the common data, which is stored in a phase state table. A new phase state table is created periodically by one of the servers and is distributed to the other servers in the cluster. The phase state table is created from a current state table. The phase state table and the current phase table are described in more detail below.

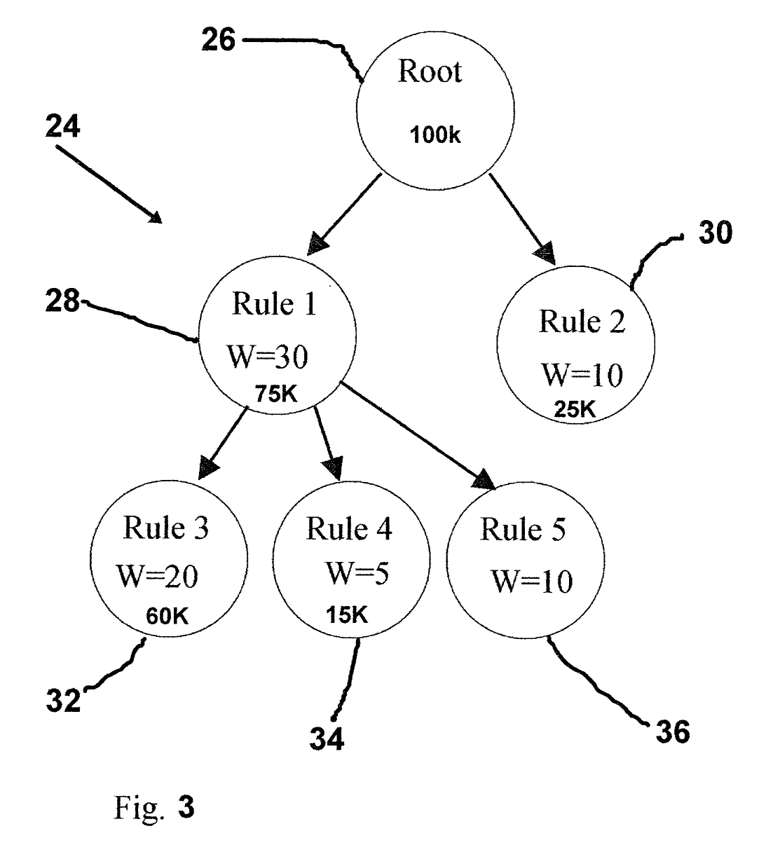

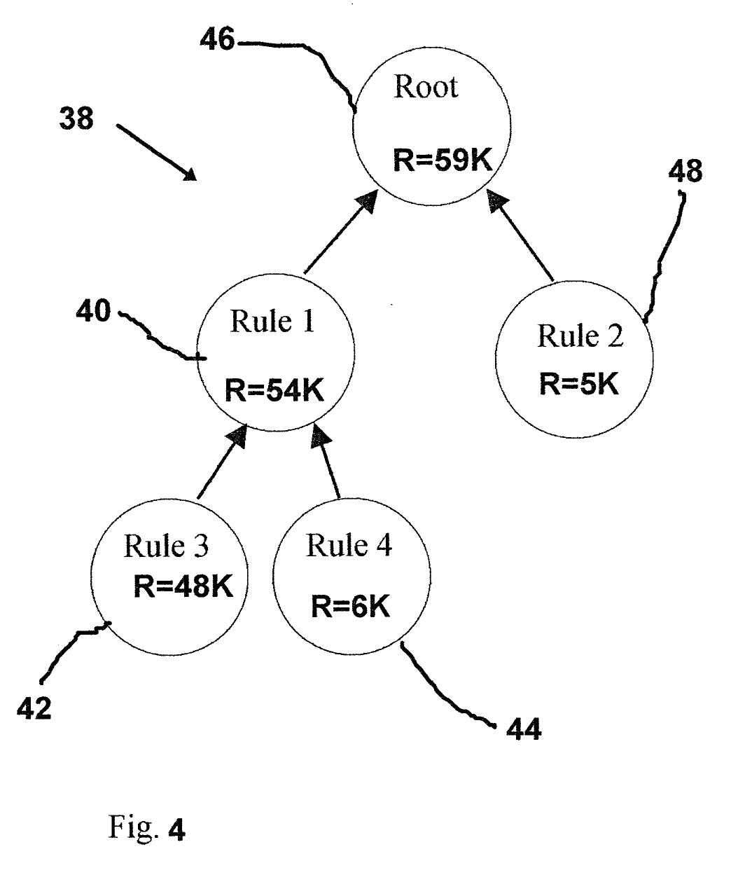

Each of the servers maintains a current state table. An example of a current state table is shown in Table 1. In the example of Table 1 and the other illustrative examples of Table 2, 3 and 4 and FIG. 3 and FIG. 4 described herein, the cluster of servers includes two servers. The data set of the current state table includes for each of the servers, a current measurement of a usage of the link for each of the terminal rules. The measurement of the usage of the link is typically a measurement of the number of backlogged connections.

TABLE 1
Example of a current state table

| | Rule 2 | Rule 3 | Rule 4 | Rule 5 |
|---|---|---|---|---|
| Server 1 | 12 | 2 | 3 | 0 |
| Server 2 | 3 | 8 | 2 | 0 |

In the example of Table 1, there are 4 terminal rules, namely, rule 2, rule 3, rule 4 and rule 5. For example, for rule 2, server 1 has 12 backlogged connections and server 2 has 3 backlogged connections. The measurement of the usage of the link for each of the terminal rules is described herein as current in that a measurement of the usage of the link for each of the terminal rules is taken at least once per phase. The current state table is updated by synchronizing the data set of the current state table between the cluster servers. Typically, each server calculates a part of the data set associated with its usage of the link and shares this part of the data set with the other servers in the cluster.

The entry of a server in the current state table has a predefined timeout value. Therefore, when a server fails, its entry eventually expires and its entry is deleted from the current state table. An expiring entry is equivalent to a server scheduling no connections. In this way, the next recalculation of localized policies divides the unused bandwidth of the failed server among the active servers.

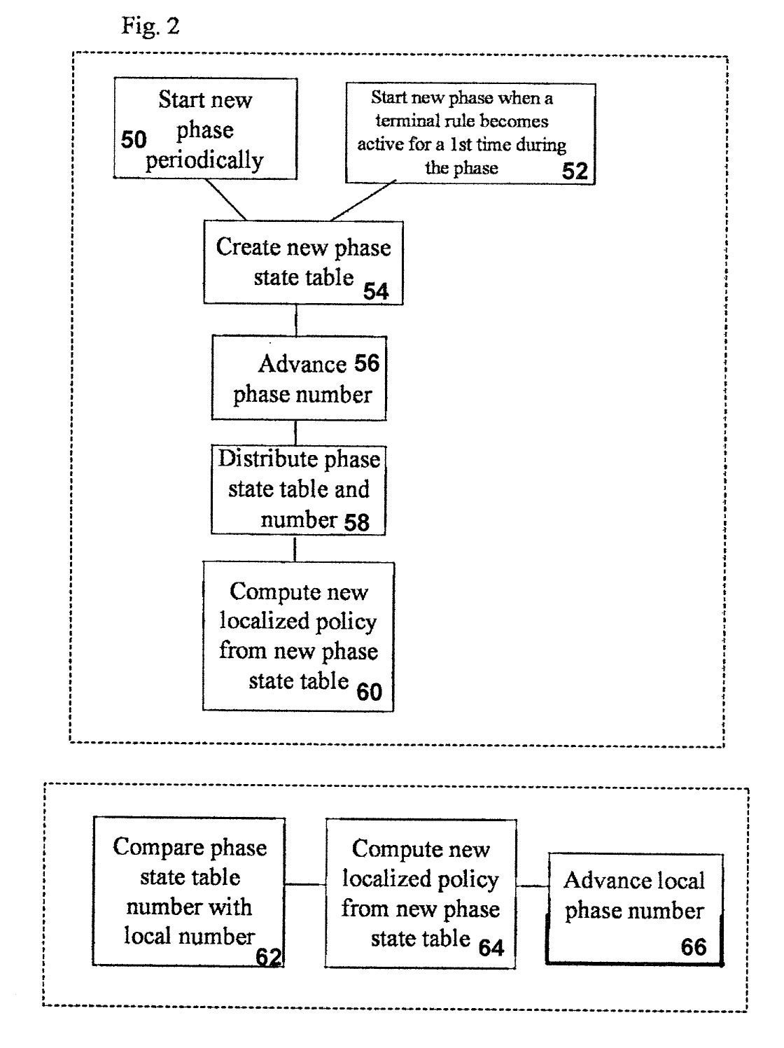

FIG. 2 is a flowchart of some of the steps performed during a phase that is operable in accordance with a preferred embodiment of the invention. The server that creates a new phase state table is called the master server. The master server is typically chosen as the server having the highest or lowest server identification (ID) that has an active entry in the current state table. For example, a cluster has three servers, namely, server 1, server 2 and server 3, all servers having active entries in the current state table. If the master server is chosen to be the server with the lowest server ID, then server 1 is designated to be the master server. If server 1 fails, the entry of server 1 in the current state table expires and server 2, being the lowest server ID that is active in the current state table, is designated as the master server. Therefore, each server maintains the time of the last phase so that if a server is designated as the master server, that server knows when to start a new phase based on the time elapsed since the last phase. When the designated master server decides to start a new phase (Block 50, Block 52), the master server creates a new phase state table (Block 54) by copying the data set of its current state table to form the new phase state table. A new phase is started, by the master server, on a periodic basis (Block 50), typically every 100 msec., to follow the variations in the number connections matching the active rules. Alternatively, a new phase is started, by the master server, when a terminal rule at a server becomes active for the first time since the last computation of the localized policy was performed by that server (Block 52). Each phase has an associated phase number and every server in the cluster maintains a local phase number. In addition, each phase state table has an associated phase number. The master server adds one to the phase number of the previous phase state table to create a new phase number (Block 56). The previous phase state table is the phase state table in existence immediately prior to the new phase state table. The master server then distributes the new phase state table with the new phase number to the other servers in the cluster (Block 58). All the servers, including the master server, compute a new localized policy with respect to the new state from the data set of the new phase state table (Block 60). The computation of a new localized policy by all the servers, including the master server, is triggered by the following mechanism. When a server detects that the phase number of its phase state table is greater than its local phase number (Block 62), that server computes a new localized policy for itself with respect to the new state from the data set of the new phase state table (Block 64). That server then advances its local phase number to match the phase number of the new phase state table (Block 66). The above methods ensure that all the localized polices are calculated with respect to the same state.

By way of introduction, as mentioned above, in a centralized policy the rate of a terminal rule is divided equally among the matching connections. However, in a cluster environment, connections matching the same terminal rule are divided among different servers of the cluster. Therefore, the present invention includes an algorithm to create a localized policy for each server of the cluster. In overview the algorithm is as follows. Firstly, the terminal rule rates under the centralized policy are calculated taking into account inactive terminal rules. Secondly, a given terminal rule of a given server is computed by prorating the rate of the given terminal rule under the centralized policy according to the usage of the link by the given server for the given terminal rule. In this way, the rates of all the terminal rules, for all the servers, are calculated under a localized policy. Thirdly, once the terminal rule rates for each server have been calculated, the rates of the other rules for each server are calculated by summing up the rates of their respective sub-rules. Finally, the rate of the root node for each server is determined. The root node rate under a localized policy represents the total bandwidth available to a server for the phase. The algorithm is described in more detail below.

Firstly, the terminal rule rates under the centralized policy are calculated from the weighting allocation of the centralized policy and the activity status of the rules for the cluster as a whole. The activity status of a rule is inactive if there are no backlogged connections matching the rule. Otherwise, the rule is active. It should be noted that the weighting allocation of the centralized policy may be defined in terms of: the weight of sub-rules with respect to the parent of the sub-rules; or the actual bandwidth rates allocated to each rule assuming that each rule is active; or a fraction of the link bandwidth allocated to each rule assuming that each rule is active or any method to that enables allocation of the centralized policy. By way of example, reference is now made to FIG. 3, which is an example of a centralized policy rate hierarchy 24 that is constructed and operable in accordance with a preferred embodiment of the present invention. Reference is also made to Table 2, which is an example of a phase state table. For illustrative purposes, phases 1 and 2 have already occurred and the phase state table of Table 2 was created at the beginning of phase number 3. The phase state table of Table 2 was created by copying the data set of the current state table of Table 1. As the phase number associated with a phase state table is distributed with the phase table, the phase number is typically attached to the phase state table, as shown in Table 2. It is seen from Table 2 that rules 2, 3 and 4 are active and rule 5 is inactive, at both servers.

TABLE 2
Example of a phase state table

| Phase #3 | Rule 2 | Rule 3 | Rule 4 | Rule 5 |
|---|---|---|---|---|
| Server 1 | 12 | 2 | 3 | 0 |
| Server 2 | 3 | 8 | 2 | 0 |

Centralized policy rate hierarchy 24 has five rules below a root node (circle 26). The rate of root node (circle 26) is 100K. Below the root node (circle 26) are two rules, rule 1 (circle 28) and rule 2 (circle 30). With respect to the root node (circle 26), rule 1 (circle 28) has a weight of 30 and rule 2 (circle 30) has a weight of 10. Therefore, 75K bandwidth rate is allocated to rule 1 (circle 28) and 25K bandwidth rate is allocated to rule 2 (circle 30). Rule 2 (circle 30) is a terminal rule and therefore does not have any sub-rules. Rule 1 (circle 28) has three sub-rules, rule 3 (circle 32), rule 4 (circle 34) and rule 5 (circle 36). With respect to rule 2 (circle 30), rule 3 (circle 32) has a weight of 20, rule 4 (circle 34) has a weight of 5 and rule 5 (circle 36) has a weight of 10. The 75K bandwidth rate allocated to rule 1 (circle 28) is now allocated amongst rule 3 (circle 32), rule 4 (circle 34) and rule 5 (circle 36). However, as rule 5 (circle 36) is inactive, the 75K bandwidth rate of rule 1 (circle 28) is allocated amongst rule 3 (circle 32) and rule 4 (circle 34) according to their respective weights. Therefore, a 60K bandwidth rate is allocated to rule 3 (circle 32) and a 15K bandwidth rate is allocated to rule 4 (circle 34). The allocation of the rates to the rules under the centralized policy is summarized in table 3.

TABLE 3
Rates of rules under recalculated centralized policy

| | Rule 1 | Rule 2 | Rule 3 | Rule 4 | Rule 5 |
|---|---|---|---|---|---|
| Rate | 75 K | 25 K | 60 K | 15 K | 0 K |

Secondly, a given terminal rule of a given server is computed by prorating the rate of the given terminal rule under the centralized policy according to a measurement of the usage of the link by the given server for the given terminal rule. In this way, the rates of all the terminal rules, for all the servers, are calculated under a localized policy. This can be expressed as a formula:

R=R_{C}×N_{L}/N_{T} (Equation 1)

where R is the rate of a given terminal rule under a localized policy which is associated with a given server; R_{C} is the rate of the given terminal rule under a centralized policy; N_{L} is a measurement of the usage of the link by the given server matching the given terminal rule and N_{T} is a measurement of the usage of the link by the cluster as a whole matching the given terminal rule. In accordance with the most preferred embodiment of the invention the measurement of the usage of the link is measured by a quantity of backlogged connections. Therefore, according to the most preferred embodiment of the invention, N_{L} is the quantity of backlogged connections of the given server matching the given terminal rule and N_{T} is the quantity of backlogged connections of the cluster as a whole matching the given terminal rule. The calculated rates of the terminal rules are typically expressed in terms of the actual rate or as a fraction of the link bandwidth. Reference is now made to table 4, which is a table of sample terminal rule rate calculations for phase number 3, which are calculated using the data of table 2 and table 3. The quantity of backlogged connections for the cluster is simply the addition of the quantity of backlogged connections for server 1 and server 2.

TABLE 4
Sample terminal rule rate calculations

| Phase #3 | Rule 2 | | Rule 3 | | Rule 4 | | Rule 5 | |
|---|---|---|---|---|---|---|---|---|
| Server 1 | 12 | | 2 | | 3 | | 0 | |
| backlogged connections | | | | | | | | |
| Server 2 | 3 | | 8 | | 2 | | 0 | |
| backlogged connections | | | | | | | | |
| Cluster | 15 | | 10 | | 5 | | 0 | |
| Backlogged connections | | | | | | | | |
| Centralized Policy Rate | 25 | K | 60 | K | 15 | K | 0 | K |
| Localized policy rate for | 20 | K | 12 | K | 9 | K | 0 | K |
| Server 1 | | | | | | | | |
| Localized policy rate for | 5 | K | 48 | K | 6 | K | 0 | K |
| Server 2 | | | | | | | | |

Thirdly, once the terminal rule rates for each server have been calculated, the rates of the other rules, the non-terminal rates, for each server are calculated by summing up the rates of their sub-rules. This is achieved by summing the rates of the direct sub-rules of a given non-terminal rule or by summing all the rates of all the terminal rules which are below the given non-terminal rule in the hierarchy of the given localized policy. The calculated rates of the non-terminal rules are typically expressed in terms of the actual rate or as a fraction of the link bandwidth.

Finally, the rate of the root node for each server is determined. The root node rate under a localized policy represents the real interface speed or the total bandwidth available to a server. The real interface speed for a given server is computed such that it is equal to the sum of the rates of the terminal rules for the given server. The real interface speed for a given server is also equal to the sum of the rates of the rules directly below the root node for the given server. If the rates of the terminal rule are expressed as a fraction of the link bandwidth then the calculated real interface speed is expressed as a fraction of the link bandwidth.

By way of example, reference is now made to FIG. 4, which is a localized policy rate hierarchy 38 for server 2 computed with reference to the centralized policy rate hierarchy of FIG. 3 for phase number 3. The rates of the terminal rules for server 2 are given in table 4. The rate of rule 1 (circle 40) is calculated by adding the rates of rule 3 (circle 42) and rule 4 (circle 44), giving a rate of rule 1 (circle 40) of 54K. The rate of the root node (circle 46) is calculated by either adding the rates of rule 1 (circle 40) and rule 2 (circle 48) or by adding the rates of rule 2 (circle 48), rule 3 (circle 42) and rule 4 (circle 44), giving a rate of the root node (circle 46) of 59K. Therefore, for the duration of phase 3, the total allocated bandwidth for server 2 is limited to 59K. A similar computation for server 1, gives a total allocated bandwidth for server 1 of 41K. Therefore, the bandwidth rate of the link of 100K is totally allocated between server 1 and server 2.

It should be noted that the rates of the rules calculated at the beginning of a phase for a given localized policy also act as a weighting allocation for the localized policy during the phase itself. By way of example, reference is again made to FIG. 4. If rule 2 (circle 48) becomes inactive for server 2 during the time period of phase 3, the rate allocated to rule 2 (circle 48) of 5K is allocated to rule 1 (circle 40). Therefore, the new rate of rule 1 (circle 40) is 59K. The rate of rule 1 (circle 40) is allocated to rule 3 (circle 42) and rule 4 (circle 44) according to their weights with respect to rule 1 (circle 40). The weights of rule 3 (circle 42) and rule 4 (circle 44) are 48 and 6 respectively, also being proportional to the previously calculated rates of 48K and 6K of rule 3 (circle 42) and rule 4 (circle 44) respectively. Therefore, rule 3 (circle 42) is allocated a new rate of approximately 52.44K and rule 4 (circle 44) is allocated a new rate of approximately 6.56K. If rule 2 (circle 48) becomes active again during phase 3, rule 2 recaptures the allocated bandwidth of 5K and the rates of rule 3 (circle 42) and rule 4 (circle 44) revert back to the original calculated rates according to the calculated localized policy.

It will be appreciated by persons skilled in the art that the present invention is not limited to what has been particularly shown and described hereinabove. Rather, the scope of the present invention includes both combinations and sub-combinations of the various features described hereinabove, as well as variations and modifications thereof that are not in the prior art which would occur to persons skilled in the art upon reading the foregoing description.

What is claimed is:

1. A method to manage a bandwidth of a link that is available to a cluster of servers, comprising the steps of:
(a) establishing a localized bandwidth management policy for at least one of the servers at least partially from a centralized management policy of the cluster, said localized policy and said centralized policy being based on a hierarchical policy having a plurality of rules associated with classes of connections that are routed through the link, each of said rules having an associated rate, said plurality of rules including a plurality of terminal rules, said step of establishing being performed by prorating said rate of at least one of said terminal rules under said centralized policy according to a first measurement of a usage of the link by said at least one server for said at least one terminal rule; and
(b) operating said at least one server according to said localized policy.

2. The method of claim 1, wherein said first measurement is measured by a quantity of backlogged connections.

3. The method of claim 1, wherein said step of establishing is performed by all of the servers.

4. The method of claim 1, wherein said step of establishing is performed by said at least one server.

5. The method of claim 1, wherein said step of establishing is performed by another of the servers for said at least one server.

6. The method of claim 1, wherein said step of establishing includes computing said rate of said at least one terminal rule under said centralized policy from a weighting allocation and an activity status of at least one of said rules for the cluster.

7. The method of claim 1, wherein:
(a) said plurality of rules includes a plurality of non-terminal rules; and
(b) said step of establishing includes computing said rate of at least one of said non-terminal rules under said localized policy such that, said rate of said at least one non-terminal rule is substantially equal to a sum of said rates of said terminal rules which are below said at least one non-terminal rule under said localized policy.

8. The method of claim 1, wherein said step of establishing includes computing an interface speed for said at least one server such that, said interface speed is proportional to a sum of said rates of said terminal rules under said localized policy.

9. The method of claim 1, further comprising the step of creating a phase state table by one of the servers, wherein said phase state table has a data set which includes, for each of the servers, a second measurement of said usage of the link for each of said terminal rules.

10. The method of claim 9, wherein said second measurement is measured by a quantity of backlogged connections.

11. The method of claim 9, wherein said step of creating is performed on a periodic basis.

12. The method of claim 9, wherein said step of creating is performed when one of said terminal rules becomes active for a first time since said step of establishing was performed.

13. The method of claim 9, wherein said step of establishing is performed using said data set of said phase state table.

14. The method of claim 9, further comprising the step of at least one of the servers maintaining a current state table, wherein said current state table has a data set which includes, for each of the servers, a current measurement of said usage of the link for each of said terminal rules.

15. The method of claim 14, wherein said current measurement is measured by a quantity of backlogged connections.

16. The method of claim 14, further comprising the step of deleting said data set of said current state table which is associated with one of the servers after a predefined timeout.

17. The method of claim 14, wherein said step of maintaining includes synchronizing at least part of said data set of said current state table between at least two of the servers.

18. The method of claim 14, wherein said step of creating is performed by using said data set of said current state table to form said phase state table.

19. The method of claim 9, further comprising the step of distributing said phase state table to at least another of the servers.

20. The method of claim 19, further comprising the steps of:
(a) prior to completion of said step of distributing, assigning a new phase number to said phase state table such that said new phase number is equal to a phase number of a previous phase state table plus one; and
(b) distributing said phase state table with said new phase number.

21. The method of claim 20, wherein said step of establishing is performed by one of the servers when said new phase number is greater than a local phase number, which is maintained locally by one of the servers; the method further comprising the step of setting said local phase number to be equal to said new phase number.
